(19) United States
(12) Patent Application Publication
(10) Pub. No.: US 2021/0394281 A1
(43) Pub. Date: Dec. 23, 2021

(54) DRILL AND INSERT FOR DRILL HAVING IMPROVED CENTERING CAPABILITY AND CUTTING PERFORMANCE

(71) Applicant: YG-1 CO., LTD., Incheon (KR)

(72) Inventors: Young Koon PARK, Incheon (KR); Jung Wook LEE, Incheon (KR)

(73) Assignee: YG-1 CO., LTD., Incheon (KR)

(21) Appl. No.: 17/285,042

(22) PCT Filed: Sep. 18, 2019
(86) PCT No.: PCT/KR2019/012029

§ 371 Date: Apr. 13, 2021

(30) Foreign Application Priority Data
Dec. 7, 2018 (KR) 10-2018-0156797

(51) Int. Cl. B23B 51/02

(52) U.S. Cl. CPC B23B 51/02

(57) ABSTRACT

Disclosed are a drill and an insert for a drill having improved centering capability and cutting performance. In the drill of the present disclosure, central relief surfaces of cutting parts are processed as flat relief surfaces, and outer circumferential relief surfaces continuing from the center part to the outer circumferential surface of the drill are processed as curved relief surfaces, thereby enhancing the centering capability of the drill and minimizing the generation of drill vibration and burrs. In addition, in the drill of the present disclosure, the outer relief surfaces of the drill in contact with a hole to be drilled are processed such that an angle between the tangential lines of the outer relief surfaces is constant regardless of the size of the outer diameter of the drill, thereby achieving consistent performance of the drill despite change in the outer diameter of the drill.

### TECHNICAL FIELD

The present disclosure relates to a drill and an insert for a drill, in which flat relief surfaces are formed at the center part of the drill such that a point angle between the flat relief surfaces is constant to enhance the centering capability of the drill, and curved relief surfaces are formed at the outer circumferential part of the drill to solve problems caused by abrupt change in the point angle, whereby the generation of drill vibration and burrs is minimized.

### BACKGROUND ART

A drill as a rotary tool such as an end mill includes a cutting part provided at a distal end thereof and having cutting teeth machined along a central axis thereof which is a rotation axis and a spindle body provided at a rear end of the cutting part and extending therefrom.

A drill is divided into an integrated solid type drill and an indexable type drill which is used by fitting an insert to a drilling point of the drill. The solid drill cannot be used when a cutting part of the distal end part of the solid drill is worn out, and thus the entirety of the solid drill is required to be exchanged with a new one. On the other hand, the indexable drill is a drill in which a cutting part and a spindle body are manufactured separately from each other. The cutting part as an insert type is used by being combined with the spindle body and held therein by several holding members. When the life of the cutting part ends, the cutting part can be removed from the spindle body and replaced.

A drill includes a cutting part formed along a central axis thereof and a spindle body provided at the rear end of the cutting part. The cutting part includes a land part having a cutting tooth formed along a longitudinal direction of an outer circumference thereof and a flute for discharging chips, the land part and the flute being alternately formed, and the spindle body is combined with a drill machine by holding a drill shank to the machine. FIG. 1 is a view illustrating a head of a conventional twist drill, in which two cutting parts are arranged symmetrically to each other, and two flutes are arranged symmetrically to each other, relative to a drill point of the conventional twist drill. FIGS. 2(a), 2(b), and 2(c) illustrate sections taken along line A-A of FIG. 1. Each of the sections of A-A is a section taken along a boundary line of reliefs of the two cutting parts arranged symmetrically to each other by crossing the drill point 11. FIG. 2(a) is an example of a relief surface configured as a flat surface, in which a line ranging from the drill point 11 to the outer circumferential surface 12 of the drill is represented as one straight line 13. FIG. 2(b) illustrates an example in which a relief ranging from the drill point 11 to the outer circumferential surface 12 is configured to have two flat surfaces, wherein the relief is represented as two straight lines 14 and 15. FIG. 2(c) illustrates an example of a relief surface configured as a curved surface, in which a line ranging from the drill point 11 to the outer circumferential surface 12 is represented as a curved line. FIGS. 2(b) and 2(c) illustrate examples in which a center part 16 adjacent to the drill point 11 and an outer circumferential part 17 connected to the center part 16 are processed to have point angles different from each other.

Since the drill having a point angle as illustrated in FIG. 2(a) is easy to be processed, the drill is relatively inexpensive and is widely used. A normal point angle 81 of a conventional drill is 118°˜150°, and an optimal angle is applied thereto as required. The drill 10 having a small point angle has an excellent centering capability such that the movement of a center point of a hole formed during the penetration of a workpiece is prevented, but produces many burrs at the entrance and exit of the penetrated hole. However, in a case in which a drill having a large point angle is applied, the center of the rotating drill 10 is moved when operating in a state in which the rigidity of equipment is weak or the supported state of a workpiece is not secure, and thus vibration may occur between the workpiece and the drill 10. Such vibration leads to the breakage of the drill and poor hole quality. Particularly, when a thin plate is processed, due to elasticity of the thin plate, it is highly likely that external force caused by the spring back of the thin plate occurs in addition to cutting resistance occurring during drilling, so the drill may break and relatively many burrs are produced.

In the drill in FIG. 2(b), a point angle θ1 of the center part 16 of the drill is less than 140°, and the point angle θ2 of the outer circumferential part 17 extending from the center part 16 in a direction toward the outer circumferential surface 12 is more than 140°, so the problem of the drill in FIG. 2(a) can be solved to some extent. Due to the small size of a central point angle θ1, the drill is excellent in a centering capability during drilling a hole, and has the relatively small amount of burrs produced in the drilled hole due to the large size of an outer circumferential point angle θ2.

In the drill in FIG. 2(b), the relief of the outer circumferential part 17 is processed as a flat surface, so despite change in the outer diameter of the drill, the outer circumferential point angle θ2 can be maintained to be constant as in the drill of FIG. 2(a).

However, the problem of the drill in FIG. 2(b) lies in two point angles thereof. After the center part 16 of the drill enters a workpiece, the outer circumferential part 17 of the drill touches the workpiece and starts drilling. The problem is that the point angle of the drill changes when the outer circumferential part 17 starts drilling. This means that the torque and thrust of the drill change abruptly, which may cause vibration of the drill and make cutting mechanism of the drill unstable. As a result, the quality of a hole to be drilled may deteriorate or the drill may break.

Meanwhile, to improve the centering of a drill, when drilling a hole by the drill illustrated in FIG. 2(b) after a pilot hole is first drilled by the drill having the same outer diameter illustrated in FIG. 2(a), the outermost point of the outer circumferential part 17 touches a workpiece before the center part 16 of the drill and may start cutting. As a result, it is impossible to perform the stable centering of the drill.

The drill illustrated in FIG. 2(c) has the entirety of a relief surface configured as a curved surface. The section of the relief surface 18 illustrated in FIG. 2(c) is a curve having one radius or a plurality of radii from the drill point 11 to the outer circumferential surface 12. When the relief surface 18 is a curve, the point angle of the center part 16 and the point angle of the outer circumferential part 17 are different from each other like the drill illustrated in FIG. 2(b), so an effect similar to the effect obtained by the drill of FIG. 2(b) can be obtained. Furthermore, change between the two point angles does not occur abruptly, so problems caused by abrupt change in torque and thrust do not occur. However, the drill of FIG. 2(c) has an outer circumferential point angle 82 changing according to the outer diameter of the drill, so despite the use of drills having the same shapes, it is difficult to obtain the constant quality of a hole according to the size of the hole to be drilled.

### DOCUMENT OF RELATED ART

Korean Patent Application Publication No. 10-2009-0096230 (Indexable insert drill)

### DISCLOSURE

### Technical Problem

The present disclosure is intended to propose a drill and an insert for a drill, in which flat relief surfaces are formed at the center part of the drill such that a point angle between the flat relief surfaces is constantly small to enhance the centering capability of the drill, and curved relief surfaces are formed at the outer circumferential part of the drill to solve problems caused by abrupt change in the point angle, whereby the generation of drill vibration and burrs is minimized.

In addition, the present disclosure is intended to propose a drill and an insert for a drill, in which the outer circumferential relief surfaces are formed as curved surfaces, and the point angles of the outer circumferential part of the drill being in contact with a hole to be drilled are constant irrespective of the size of the outer diameter of the drill.

### Technical Solution

In order to accomplish the above objectives, a twist drill according to the present disclosure has a plurality of cutting parts and flutes formed alternately. Here, the cutting parts include central relief surfaces and outer circumferential relief surfaces. Each of the central relief surfaces is in contact with a chisel edge, and is processed as a flat surface. Each of the outer circumferential relief surfaces is formed by extending from the central relief surface in a direction toward an outer circumferential surface of the drill, and is configured as a curved surface having at least one radius. Here, a point angle between the outer circumferential relief surfaces in contact with the central relief surfaces is the same as a central point angle (the central point angle is an angle defined by the central relief surfaces).

According to an embodiment of the present disclosure, the central relief surface and the outer circumferential relief surface may be divided into a first relief surface in contact with a cutting edge and a second relief surface extending from the first relief surface and having a relief angle larger than a relief angle of the first relief surface.

According to an embodiment of the present disclosure, a central point angle between the central relief surfaces of the plurality of cutting parts may be set to be 140° or less, and an outer circumferential point angle between the outer circumferential relief surfaces of the plurality of cutting parts may be set to be 140° or more, wherein the outer circumferential point angle may be defined by tangential lines of the outer circumferential relief surfaces meeting the outer circumferential surface.

Meanwhile, despite change in the size of an outer diameter of the drill, the outer circumferential point angle may be set to be constant by changing at least one selected from a radius of the curved surface of each of the outer circumferential relief surfaces and a length of each of the central relief surfaces in a direction toward the outer circumferential surface.

The present disclosure is applied even to an insert mounted to an insert insertion part of the drill. The insert includes the plurality of cutting parts meeting each other at the chisel edge, wherein each of the cutting parts includes the central relief surface and the outer circumferential relief surface described above.

### Advantageous Effects

The drill according to the present disclosure has a small point angle at the center part thereof and has a relatively large point angle at the outer circumferential part of the drill, thereby enhancing a centering capability of the drill and minimizing the generation of drill vibration and burrs.

Furthermore, in the drill of the present disclosure, the outer circumferential relief surface is configured as a curved surface such that the angle of a part at which the center part extends to the outer circumferential part does not change abruptly, thereby mitigating the changes of torque and thrust of the drill and minimizing the vibration of the drill. Particularly, the drill of the present disclosure has an excellent centering capability and allows a processed surface of a workpiece to be clean, so the drill is advantageous even for the processing of a thin plate in which repulsion may occur due to elasticity of the thin plate in the process of drilling.

The drill of the present disclosure processes a workpiece with a constant outer circumferential point angle of the drill irrespective of the size of the outer diameter of the drill, thereby realizing a consistent performance of the drill despite change in the outer diameter of the drill.

### DESCRIPTION OF DRAWINGS

FIG. 1 is a top plan view illustrating a drill tip part of a conventional drill;

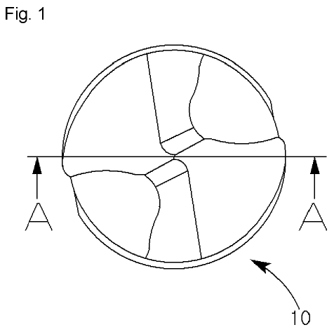

FIGS. 2(a), 2(b), and 2(c) illustrate various examples of a section taken along line A-A of the drill tip part of the drill of FIG. 1;

FIGS. 3(a), 3(b), 3(c), and 3(d) are views illustrating examples of various kinds of drills to which the technology of the present disclosure is applied;

FIG. 4 is a perspective view of an insert for an indexable drill according an embodiment of the present disclosure;

FIG. 5 is a top plan view of the insert for each drill of FIGS. 3(a), 3(b), 3(c), and 3(d); and

FIG. 6 is a sectional view taken along line B-B of the insert for each of the drills of FIGS. 3(a), 3(b), 3(c), and 3(d).

### MODE FOR INVENTION

Hereinbelow, the present disclosure will be described in detail with reference to the accompanying drawings.

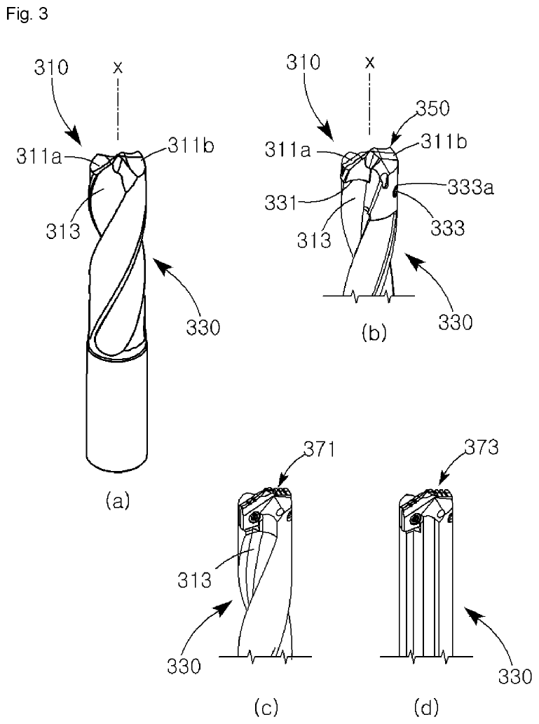

The insert of the present disclosure is applied to a normal solid drill and an indexable drill. An insert for the indexable drill, like an insert for a spade drill, has a variety of shapes according to a fastening method thereof, but any shape of the indexable drill may be applied. FIG. 3(a) illustrates an example of a normal solid drill or a welding drill, FIG. 3(b) illustrates an example of the indexable drill, and FIGS. 3(c) and 3(d) illustrate examples of a spade drill.

Referring to FIGS. 3(a) and 3(b), the drill of the present disclosure includes a drill tip part 310 formed at a distal end thereof along a rotational axis X, and a spindle body 330 provided at a rear end of the drill tip part 310. The technology of the present disclosure may be applied in a drill itself due to an embodiment thereof embodied in the drill tip part 310 of the drill, and may be applied in the insert 350 for an indexable drill or in an insert such as an insert 371 or 373 for a spade drill. Meanwhile, the technology of the drill according to the present disclosure may be applied in the insert having two cutting parts like FIGS. 3(a), 3(b), 3(c), and 3(d), and may be applied even in an insert having at least three cutting parts.

The drill tip part 310 has a plurality of cutting parts and flutes 313 formed alternately. Generally, two or three cutting parts and flutes are arranged in the drill tip part, and FIGS. 3(a) and 3(b) illustrate a twist drill having two cutting parts 311a and 311b and two flutes 313. The plurality of cutting parts are arranged to be opposite to each other relative to the rotational axis of the drill and meet each other at a chisel edge, and are spaced apart from each other at the same intervals. For example, in FIGS. 3(a) and 3(b), the two cutting parts 311a and 311b of the insert 350 are arranged to be symmetrical to each other and are in contact with each other at the chisel edge.

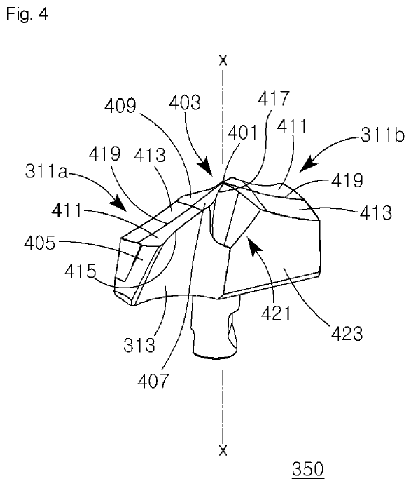

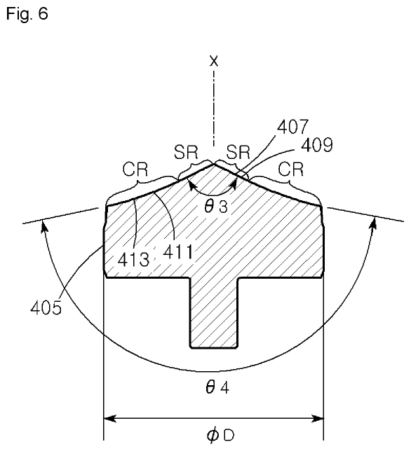

Hereinbelow, the present disclosure will be described by focusing on the insert 350 for an indexable drill illustrated in FIG. 3(b), FIG. 4, and FIG. 6. First, referring to FIG. 3(b), an insert insertion part 331 to which the insert 350 can be inserted is provided in the spindle body 330 of the drill. To hold the insert 350 inserted to the insert insertion part 331, holding holes are formed in the spindle body 330 and the insert 350 such that the holding holes correspond to each other. A holding member 333 is inserted to the holding holes such that the holding member passes through the spindle body 330 and is inserted to the insert 350, and thus the insert 350 is fastened to the spindle body 330.

As described above, in the insert 350 of FIG. 4, the two cutting parts 311a and 311b are arranged symmetrically to each other and are in contact with each other at the chisel edge 401. Each of the cutting parts 311a and 311b has the same shape and configuration, and can be described in the same way.

Each of the two cutting parts 311a and 311b includes the central relief surface 407 or 409 and the outer circumferential relief surface 411 or 413 extending radially from the rotational axis X toward the outer circumferential surface 405 of the insert. A cutting edge 415 is formed at a side of the central relief surface 407 or 409 and the outer circumferential relief surface 411 or 413 which are in contact with the flute 313. The central relief surfaces 407 or 409 of the two cutting parts 311a and 311b become thinner toward the drill point due to a web thin arranged therebetween, and thus the center part of the drill is configured to have a pointed shape. The cutting edge 415 connected from the outer circumferential relief surface 411 or 413 to the central relief surface 407 or 409 is connected to a thinning edge 417 of the center part of the drill. In the thinning edge 417, the central relief surface 407 or 409 meets the web thin 421 arranged between the central relief surface 407 or 409 and a central relief surface 407 or 409 of another cutting part.

The central relief surface 407 or 409 and the outer circumferential relief surface 411 or 413 constitute “a relief of a cutting part” in contact with the entirety of the cutting edge 415. Meanwhile, as illustrated in FIG. 4, the relief of a cutting part may include a first relief surface 407 and 411 in contact with the cutting edge 415, and a second relief surface 409 and 413 connected to the first relief surface 407 and 411, relative to a boundary line 419 of crossing the central relief surfaces 407 and 409 and the outer circumferential relief surfaces 411 and 413 in a radial direction. The second relief surface 409 and 413 has a relief angle greater than the first relief surface 407 and 411, whereby in a process of cutting, the risk of the breakage of the cutting edge 415 is lowered and during the rapid rotation of the drill, a portion of the relief surfaces is prevented from being excessively in contact with a workpiece to be processed. Accordingly, each of the cutting parts 311a and 311b includes four relief surfaces 407, 409, 411, and 413 composed of a first central relief surface 407 and a second central relief surface 409 constituting the central relief surfaces 407 and 409 and a first outer circumferential relief surface 411 and a second outer circumferential relief surface 413 constituting the outer circumferential relief surfaces 411 and 413.

Meanwhile, a solid drill illustrated in FIG. 3(a) and the insert 371 or 373 for a spade drill illustrated in FIGS. 3(c) and 3(d) include the central relief surface and the outer circumferential relief surface. However, due to the characteristics of the spade insert, a chip breaker is formed on each of the relief surfaces.

As for the characteristics of the present disclosure, the central relief surface 407 or 409 in contact with the chisel edge 401 is configured as a flat surface, and the outer circumferential relief surface 411 or 413 extending from the central relief surface 407 or 409 in a direction toward the outer circumferential surface 405 is configured as a curved surface. Here, as illustrated in FIG. 6, the curved surface of the outer circumferential relief surface 411 or 413 means that a line continuing from the rotational axis X in the direction toward the outer circumferential surface 405 is a curve. Furthermore, generally, the curve of the outer circumferential relief surface 411 or 413 is a curve having one or a plurality of radii, but is not limited hereto. For example, the curve of the outer circumferential relief surface 411 or 413 includes a spiral of Archimedes, a cycloid spline, a spiral of a trochoid, a sine curve, or even a curved (that is, a free curve) which cannot be defined to have a plurality of radii like an involute curve. The same is applied even to a spade insert 371 or 373.

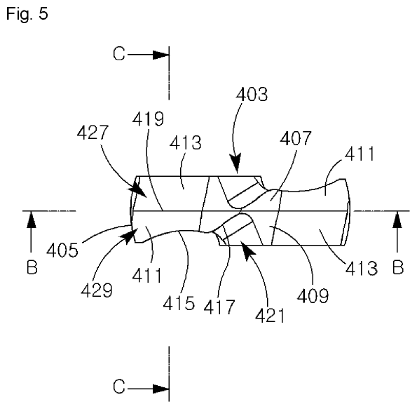

FIG. 6 illustrates a section (a section taken along line B-B of FIG. 5) crossing the central relief surfaces 407 and 409 and the outer circumferential relief surfaces 411 and 413 by crossing the rotational axis X of the insert 350, and allows whether the central relief surfaces 407 and 409 and the outer circumferential relief surfaces 411 and 413 are flat surfaces or curved surfaces to be seen. Referring to FIG. 6, since each of the central relief surfaces 407 and 409 is processed as a flat surface, the central relief surface section SR is represented as a straight line, and since each of the outer circumferential relief surfaces 411 and 413 is processed as a curved surface, the outer circumferential relief surface section CR is represented as a curved line.

The line B-B of FIG. 5 is in agreement with the boundary line 419, and when any one of the first relief surface 407 and 411 and/or the second relief surface 409 and 413 is taken in the direction of the rotational axis X, the central relief surface section SR is represented as a straight line and the outer circumferential relief surface section CR is represented as a curve. As described above, the curved surface of the outer circumferential relief surface 411 or 413 means that a line continuing from the rotational axis X to the outer circumferential surface 405 is a curve. Accordingly, the section of the outer circumferential relief surface 411 or 413 is represented as a straight line in a section taken along line C-C perpendicular to a section taken along line B-B.

The curve of the outer circumferential relief surface section CR may have one radius and may be designed as an arc, and may be designed as a curve having at least two radii. The radius of the curve of the outer circumferential relief surface section CR extending to the outer circumferential surface 405 increases according to the size of the outer diameter ØD of the drill, and is preferably approximately at least 1.5 times the outer diameter ØD of the drill.

Meanwhile, when seen in a direction perpendicular to the thickness surface 423 of the insert in FIG. 4, the shape of the thinning edge 417 and the shape of the cutting edge 415 of the insert 350 may not be the same as the shape of the straight line of the central relief surface section SR and the shape of the curved line of the outer circumferential relief surface section CR in FIG. 6, respectively, according to the shape of the flute 313 and the shape of the web thin 421.

Referring to FIG. 6, a central point angle θ3 defined by the central relief surfaces 407 or 409 and an outer circumferential point angle θ4 defined by the outer circumferential relief surfaces 411 or 413 are all designed as obtuse angles. Preferably, the central point angle θ3 is set to be 115° to 135° which is less than 140°, and the outer circumferential point angle θ4 is set to be an angle greater than 140°. Here, the central point angle θ3 is an angle defined by the central relief surfaces 407 or 409 relative to the rotational axis X, and the outer circumferential point angle θ4 is an angle defined by tangential lines at the outermost points of the outer circumferential relief surfaces 411 or 413 meeting the outer circumferential surface 405. If a drill is a drill (or an insert) having the two cutting parts 311a and 311b illustrated in FIG. 4, the central point angle θ3 of the drill is an angle between the central relief surfaces 407 or 409 of the two cutting parts 311a and 311b, and the outer circumferential point angle θ4 is an angle between the tangential lines at the outermost points of the outer circumferential relief surfaces 411 or 413 of the two cutting parts 311a and 311b. If a drill is a drill (or an insert) having at least three cutting parts, the central point angle θ3 of the drill is twice the unfolding angle of each of central relief surfaces relative to the rotational axis X, and the outer circumferential point angle θ4 of the drill is twice the unfolding angle of each of the tangential lines at the outermost points of the outer circumferential relief surfaces relative to the rotational axis X.

Since the central relief surface section SR is represented as a straight line, the central point angle θ3 is constant in the central relief surface section SR, and is formed to be less than 140°, so the centering capability of the drill can be maintained to be excellent as a whole.

On the other hand, since the outer circumferential relief surface section CR is represented as a curve, the outer circumferential point angle is not constant in the outer circumferential relief surface section CR. That is, the outer circumferential point angle gradually increases in a radial direction toward the outer circumferential surface 405 from the rotational axis X and becomes the largest angle when the outer circumferential relief surface section CR meets the outer circumferential surface 405. Accordingly, as illustrated in FIG. 6, the outer circumferential point angle θ4 can be obtained by an angle between the tangential lines of the outer circumferential relief surfaces 411 or 413 in contact with the outer circumferential surface 405. In the drill, the central point angle θ3 and the outer circumferential point angle θ4 are important factors which determine the performance of the drill. Accordingly, although the outer diameter ØD of the drill increases, the outer circumferential point angle θ4 is preferably set to be constant. To maintain the constancy of the outer circumferential point angle θ4 irrespective of the increase of the outer diameter ØD of the drill, the radius of the curve of the outer circumferential relief surface section CR and the length of the central relief surface 407 or 409 in the direction toward the outer circumferential surface may be changed according to the size of the outer diameter ØD of the drill.

The point angle between the outer circumferential relief surfaces 411 or 413 in contact with the central relief surfaces 407 or 409 is defined to be the same as the central point angle θ3, so difference between the point angle between the central relief surfaces 407 or 409 and the point angle between the outer circumferential relief surfaces 411 or 413 is not large. Accordingly, abrupt change in the torque and thrust of the drill does not occur. The outer circumferential point angle θ4 has an angle larger than 140°, so burrs produced in the penetrated hole can be minimized.

However, since the relief angle of the first relief surface 407 and 411 and the relief angle of the second relief surface 409 and 413 are different from each other, the outer circumferential point angle θ4 may be minutely changed even in the same insert 350 when the line B-B is located at a position different from the position of the boundary line 419.

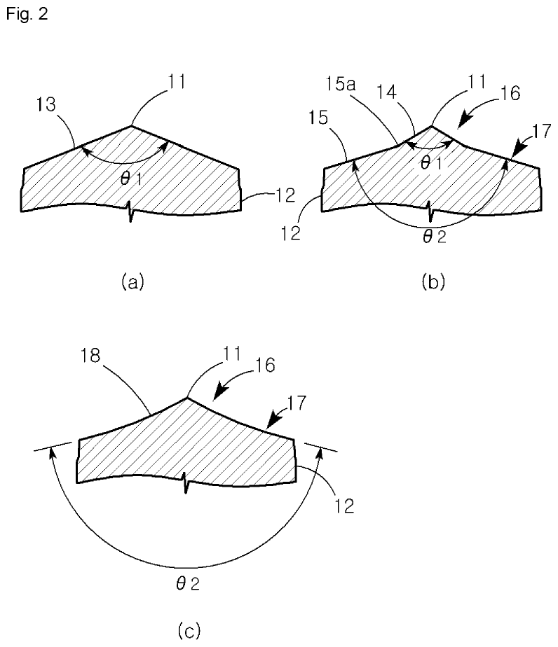

Meanwhile, a part ranging from the chisel edge of the drill point to the outermost point of the cutting edge is preferably processed such that the height of the outermost point of the cutting edge is the same as the height of the outermost edge part of the drill of FIG. 2(a). This is because in the process of selecting the drill of the present disclosure, when a drill having the same outer diameter as the outer diameter of the conventional drill 10 is selected, a hole having the same depth and size can be drilled. Accordingly, although the drill of the present disclosure is selected in place of the conventional drill, there is no need to change other settings of a tool.

In the above, the exemplary embodiment of the present disclosure has been shown and described, but the present disclosure is not limited to the specific embodiment described above. Of course, various modifications of the embodiment can be implemented by a person with ordinary knowledge in the technical field to which the present disclosure belongs without departing from the gist of the present disclosure claimed in the claims. Such modified embodiments should not be understood individually from the technical idea or perspective of the present disclosure.

1. A drill having a plurality of cutting parts and flutes formed alternately, the drill comprising:
cutting parts comprising central relief surfaces being in contact with a chisel edge and processed as flat surfaces, and outer circumferential relief surfaces formed by extending from the central relief surfaces in directions toward an outer circumferential surface of the drill and configured as curved surfaces, each of the curved surfaces having at least one radius.

2. The drill of claim 1, wherein a point angle between the outer circumferential relief surfaces in contact with the central relief surfaces is the same as a central point angle between the central relief surfaces, wherein the central point angle is an angle defined by the central relief surfaces.

3. The drill of claim 2, wherein each of the central relief surfaces and each of the outer circumferential relief surfaces are divided into a first relief surface in contact with a cutting edge and a second relief surface extending from the first relief surface and having a relief angle larger than a relief angle of the first relief surface.

4. The drill of claim 1, wherein a central point angle between the central relief surfaces of the plurality of cutting parts is set to be 140° or less, and an outer circumferential point angle between the outer circumferential relief surfaces of the plurality of cutting parts is set to be 140° or more, wherein the outer circumferential point angle is defined by tangential lines of the outer circumferential relief surfaces meeting the outer circumferential surface.

5. The drill of claim 4, wherein despite change in a size of an outer diameter of the drill, the outer circumferential point angle is set to be constant by changing at least one selected from a radius of the curved surface of each of the outer circumferential relief surfaces and a length of each of the central relief surfaces in a direction toward the outer circumferential surface.

6. An insert mounted to an insert insertion part of a drill, the insert comprising:
a plurality of cutting parts in contact with a chisel edge, wherein the cutting parts comprise central relief surfaces in contact with the chisel edge and processed as flat surfaces; and outer circumferential relief surfaces formed by extending from the central relief surfaces in directions toward an outer circumferential surface of the insert and configured as curved surfaces, each of the curved surfaces having at least one radius.

7. The insert of claim 6, wherein a point angle between the outer circumferential relief surfaces in contact with the central relief surfaces is the same as a central point angle between the central relief surfaces, wherein the central point angle is an angle defined by the central relief surfaces.

8. The insert of claim 6, wherein each of the central relief surfaces and each of the outer circumferential relief surfaces are divided into a first relief surface in contact with a cutting edge and a second relief surface extending from the first relief surface and having a relief angle larger than a relief angle of the first relief surface.

9. The insert of claim 6, wherein a central point angle between the central relief surfaces of the plurality of cutting parts is set to be 140° or less, and an outer circumferential point angle between the outer circumferential relief surfaces of the plurality of cutting parts is set to be 140° or more, wherein the outer circumferential point angle is defined by tangential lines of the outer circumferential relief surfaces meeting the outer circumferential surface.

10. The insert of claim 9, wherein despite change in a size of an outer diameter of the drill, the outer circumferential point angle is set to be constant by changing at least one selected from a radius of the curved surface of each of the outer circumferential relief surfaces and a length of each of the central relief surfaces in a direction toward the outer circumferential surface.
